(19) United States
(12) Patent Application Publication
(10) Pub. No.: US 2019/0092327 A1
(43) Pub. Date: Mar. 28, 2019

(54) VEHICLE CONTROL DEVICE

(71) Applicant: MAZDA MOTOR CORPORATION, Hiroshima (JP)

(72) Inventors: Takashi OSAKI, Aki-gun (JP); Ryo SATO, Aki-gun (JP)

(73) Assignee: MAZDA MOTOR CORPORATION, Hiroshima (JP)

(21) Appl. No.: 16/114,832

(22) Filed: Aug. 28, 2018

(30) Foreign Application Priority Data
Sep. 27, 2017 (JP) 2017-185762

(51) Int. Cl. B60W 30/14; G06K 9/00; B60W 10/06; B60W 10/18

(52) U.S. Cl. CPC B60W 30/146; G06K 9/00818; B60W 2550/40; B60W 10/18; B60W 2550/22; B60W 10/06

(57) ABSTRACT

The vehicle control device 100 comprising: a control part (ECU 10) for executing vehicle speed control for a vehicle 1 during execution of a driving support mode; a speed limit recognition part (ECU 10, navigation device 26) for acquiring a speed limit of a traveling road 3; and a traveling vehicle detection part (ECU 10) for acquiring an inter-vehicle distance and/or a relative speed with respect to a second vehicle (2a, 2b) being traveling forward/rearward of the vehicle 1, wherein the control part (ECU 10) increases/decreases the vehicle speed of the vehicle 1 to the speed limit, during the vehicle speed control, wherein the control part (ECU 10) is operable to set an acceleration/deceleration during the vehicle speed control, according to the inter-vehicle distance and/or the relative speed with respect to the second vehicle (2a, 2b) (S13 to S22).

### TECHNICAL FIELD

The present invention relates to a vehicle control device, and more particularly to a vehicle control device for executing vehicle control using a speed limit assigned to a traveling road.

### BACKGROUND ART

In recent years, various driving support modes have been provided to a driver by a driving support control system equipped on a vehicle. For example, there has been known a driving support mode in which vehicle control is performed to enable a vehicle to follow a preceding vehicle under the condition that a predetermined setup vehicle speed is an upper limit vehicle speed (see the following Patent Document 1). Further, in the Patent Document 1, the driving support mode is configured to detect a speed limit (sign-designated speed) from a speed sign imaged by a camera, and replace a current setup vehicle speed with the detected speed limit after a given time (3 seconds) from the detection. Thus, in the Patent Document 1, upon detection of a speed sign, a speed limit designated by the detected sign (sign-designated speed) is used as a new setup vehicle speed.

A driver can disable switching of a current setup vehicle speed to the sign-designated speed, by manipulate a resume switch provided on a steering wheel, within a given time period after the detection. Generally, the resume switch is a switch for switching the driving support mode from a standby state to an active state. In a case where a current setup vehicle speed is stored in a memory, in response to manipulation of the resume switch, the driving support mode is resumed or restarted using the stored setup vehicle speed.

### CITATION LIST

### Patent Document

Patent Document 1: JP 2012-206594A

### SUMMARY OF INVENTION

### Technical Problem to be Solved

However, in the Patent Document 1, the detected speed limit (sign-designated speed) is simply set as a new setup vehicle speed without taking into account surrounding vehicles (a forward (preceding) vehicle and a rearward (following) vehicle). Therefore, after the setting, if the current vehicle speed is automatically controlled to come close to the new setup vehicle speed, a vehicle is likely to approach one of the surrounding vehicles.

The present invention has been made in view of solving such problem, and the object thereof is to provide a vehicle control device capable of ensuring safety with respect to surrounding vehicles during vehicle speed control in a driving support mode.

### Solution to Technical Problem

In order to achieve the above object, the present invention provides a vehicle control device comprising: a control part operable to execute vehicle speed control for a vehicle during execution of a driving support mode; a speed limit recognition part operable to acquire a speed limit assigned to a traveling road; and a traveling vehicle detection part operable to acquire an inter-vehicle distance and/or a relative speed with respect to a second vehicle being traveling forward or rearward of the vehicle, wherein the control part is configured to increase or decrease the vehicle speed of the vehicle to the speed limit during the vehicle speed control, the control part being operable to set an acceleration or a deceleration of the vehicle during the vehicle speed control, according to the inter-vehicle distance and/or the relative speed with respect to the second vehicle.

In the vehicle control device having the above feature, a speed limit assigned to a traveling road is acquired, and the vehicle speed is controlled such that it is changed toward the speed limit. Here, if there is a second vehicle (a forward vehicle, a rearward vehicle) in the vicinity of the vehicle, the vehicle is likely to further approach the second vehicle when the vehicle speed is increased or decreased. Therefore, in the present invention, an acceleration or a deceleration of the vehicle is set according to the inter-vehicle distance and/or the relative speed between the vehicle and the second vehicle. This makes it possible to prevent approaching of the vehicle to the second vehicle when there is a change in vehicle speed during the vehicle speed control, and to thereby improve safety.

Preferably, in the vehicle control device of the present invention, when decreasing the vehicle speed of the vehicle to the speed limit during the vehicle speed control, the control part is operable to set the deceleration to a larger value, as the inter-vehicle distance with respect to the forward vehicle is smaller and/or as the relative speed at which the forward vehicle approaches the vehicle is larger.

According to this feature, when the forward vehicle is located closer to the vehicle and/or when the forward vehicle approaches the vehicle at a higher relative speed, it is possible to decrease the vehicle speed of the vehicle at a larger deceleration to thereby enable the vehicle to be promptly distanced from the forward vehicle.

Preferably, in the vehicle control device of the present invention, when decreasing the vehicle speed of the vehicle to the speed limit during the vehicle speed control, the control part is operable to set the deceleration to a smaller value, as the inter-vehicle distance with respect to the rearward vehicle is smaller and/or as the relative speed at which the rearward vehicle approaches the vehicle is larger.

According to this feature, when the rearward vehicle is located closer to the vehicle and/or when the rearward vehicle approaches the vehicle at a higher relative speed, it is possible to decrease the vehicle speed of the vehicle at a smaller deceleration to thereby decrease the relative speed at which the rearward vehicle approaches the vehicle.

Preferably, in the vehicle control device of the present invention, when increasing the vehicle speed of the vehicle to the speed limit during the vehicle speed control, the control part is operable to set the acceleration to a smaller value, as the inter-vehicle distance with respect to the forward vehicle is smaller and/or as the relative speed at which the forward vehicle approaches the vehicle is larger.

According to this feature, when the forward vehicle is located closer to the vehicle and/or when the forward vehicle approaches the vehicle at a higher relative speed, it is possible to increase the vehicle speed of the vehicle at a smaller acceleration to thereby decrease the relative speed at which the forward vehicle approaches the vehicle.

Preferably, in the vehicle control device of the present invention, when increasing the vehicle speed of the vehicle to the speed limit during the vehicle speed control, the control part is operable to set the acceleration to a larger value, as the inter-vehicle distance with respect to the rearward vehicle is smaller and/or as the relative speed at which the rearward vehicle approaches the vehicle is larger.

According to this feature, when the rearward vehicle is located closer to the vehicle and/or when the rearward vehicle approaches the vehicle at a higher relative speed, it is possible to increase the vehicle speed of the vehicle at a larger acceleration to thereby enable the vehicle to be promptly distanced from the rearward vehicle.

### Effect of Invention

The vehicle control device of the present invention is capable of ensuring safety with respect to surrounding vehicles during vehicle speed control in a driving support mode.

### BRIEF DESCRIPTION OF DRAWINGS

FIG. 1 is a block diagram of a vehicle control device according to one embodiment of the present invention.

FIG. 2 is an explanatory diagram of a manipulation unit in the vehicle control device according to this embodiment.

FIG. 3 is an explanatory diagram of vehicle control upon acquisition of a speed limit in the vehicle control device according to this embodiment.

FIG. 4A and FIG. 4B are explanatory diagrams of a display unit in the vehicle control device according to this embodiment.

FIG. 5A and FIG. 5B are explanatory diagrams presenting the relationship between an inter-vehicle distance and an acceleration/deceleration in the vehicle control device according to this embodiment.

FIG. 6A and FIG. 6B are explanatory diagrams presenting the relationship between a relative speed and an acceleration/deceleration in the vehicle control device according to this embodiment.

FIG. 7 is a processing flow of vehicle control processing in the vehicle control device according to this embodiment.

### DESCRIPTION OF EMBODIMENTS

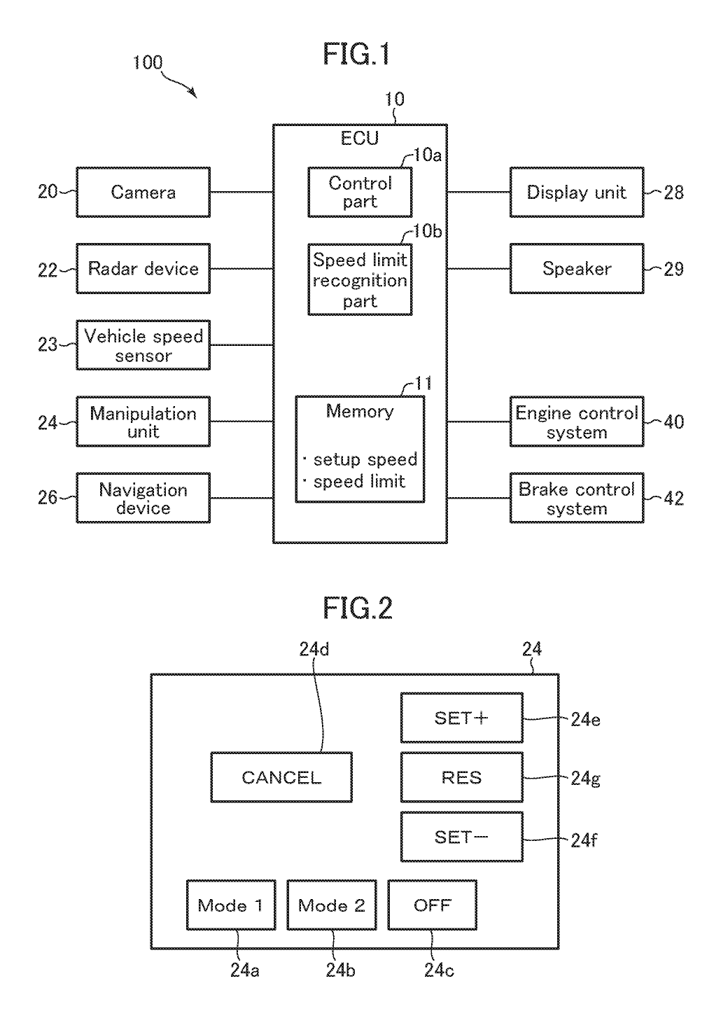

With reference to the accompanying drawings, a vehicle control device according to one embodiment of the present invention will now be described. First of all, with reference to FIGS. 1 and 2, the configuration of the vehicle control device according to this embodiment will be described. FIG. 1 is a block diagram of the vehicle control device, and FIG. 2 is an explanatory diagram of a manipulation unit in the vehicle control device.

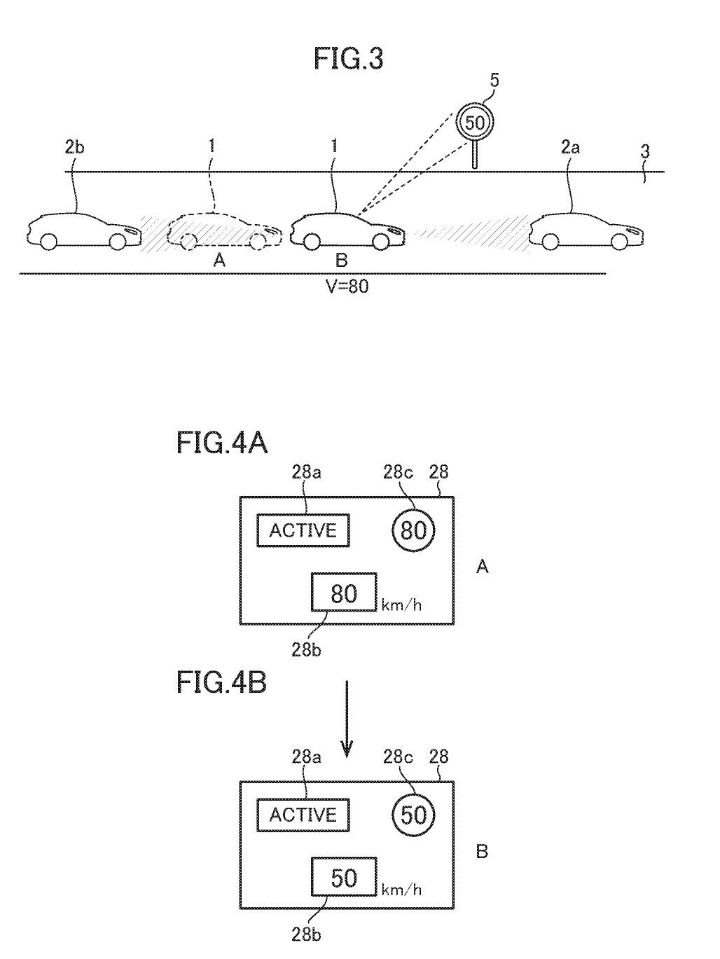

The vehicle control device 100 according to this embodiment is equipped on a vehicle 1 (see FIG. 3) and configured to execute given driving support control, depending on a driving support mode selected by a driver.

In this embodiment, the driving support mode includes a preceding vehicle following sub-mode, and a vehicle speed limiting sub-mode. The preceding vehicle following sub-mode is a mode for executing vehicle speed control and steering control of the vehicle 1, so as to execute vehicle control to enable the vehicle 1 to travel while maintaining a setup vehicle speed when there is no preceding vehicle, and to enable the vehicle 1 to follow a preceding vehicle under the condition that a setup vehicle speed serves as an upper limit vehicle speed when there is a preceding vehicle. In this vehicle speed control, the vehicle control device 100 is operable to automatically control an engine power output through an engine control system 40, and automatically control a braking force through a brake control system 42. Further, in the steering control, the vehicle control device 100 is operable to automatically control a steering angle by a steering wheel through a steering control system.

The vehicle speed limiting sub-mode is a mode for executing the vehicle control (vehicle speed control) so as to prevent the vehicle speed of the vehicle 1 from exceeding a setup vehicle speed. In this sub-mode, the engine power output is controlled according to the amount of depression of an accelerator pedal caused by manipulation of the accelerator pedal by a driver. However, when the vehicle speed of the vehicle 1 exceeds the setup vehicle speed, the vehicle control device 100 is operable to limit the vehicle speed of the vehicle 1 to the setup vehicle speed, irrespective of the depression amount of the accelerator pedal. In this case, the vehicle control device 100 is operable to reduce the engine power output through the engine control system 40, and optionally, as needed, apply the braking force through the brake control system 42.

As depicted in FIG. 1, the vehicle control device 100 comprises an electronic control unit (ECU) 10, various sensors/input-output units, and given vehicle systems. The sensors/input-output units include: an external imaging camera 20; a radar device 22 for detecting any second vehicles located forward and rearward of the vehicle 1; a vehicle speed sensor 23 for detecting the vehicle speed of the vehicle 1; a manipulation unit 24 for inputting user input regarding the driving support control; a navigation device 26; a display unit 28 for presenting information to a driver; a speaker 29; and other sensors. The vehicle systems include the engine control system 40 and the brake control system 42.

The ECU 10 comprises a computer comprising a CPU, a memory 11 for storing therein various programs and data, and an input-output device, etc. The ECU 10 includes various functions, including functions as a control part 10a and a speed limit recognition part 10b, for example.

The ECU 10 (control part 10a) is operable to display given information on the display unit 28 based on an externally received signal, and output request signals, respectively, to the vehicle systems (the engine control system 40, the brake control system 42, etc.) to execute vehicle control processing during an activated state of the driving support mode, such as the preceding vehicle following sub-mode and the vehicle speed limiting sub-mode. The data stored or to be stored in the memory 11 includes a setup vehicle speed to be used for the vehicle speed control during execution of the driving support mode, and a speed limit acquired by the speed limit recognition part 10b.

The ECU 10 (control part 10a) is operable to monitor a current value of the vehicle speed of the vehicle 1 detected by the vehicle speed sensor 23, and to execute overspeed alarm processing for generating an overspeed alarm from the speaker 29 (alarm unit) when the current vehicle speed exceeds a threshold speed. In addition to the alarm from the speaker 29, the overspeed alarm may include a visual display on the navigation device 26, the display unit 28, or the like.

Further, the ECU 10 (speed limit recognition part 10b) is operable to execute speed limit recognition processing for acquiring a speed limit (sign-designated speed) designated by a speed sign in image data captured by the camera 20 by analyzing the image data. The camera 20 is operable to capture an image of a forward field of view of the vehicle 1, and transmit data about the captured image to the ECU 10. Here, the speed limit recognition part 10b may include the camera 20, as one component thereof

The radar device 22 is operable to transmit radio waves (transmission waves) toward forward and rearward sides of the vehicle 1, and receive resulting reflected waves. Then, based on the transmission waves and the reflected waves, the radar device 22 is operable to output a signal containing measurement data about an inter-vehicle distance between the vehicle 1 and the second vehicle existing forward or rearward of the vehicle 1, and measurement data about a relative speed with respect to each of the second vehicles. Here, in place of or in addition to the radar device 22, another type of sensor such as a laser radar or a sonar may be used.

The manipulation unit 24 is installed to the steering wheel of the vehicle 1, and provided with a plurality of switches. As depicted in FIG. 2, the manipulation unit 24 comprises: two ON switches 24a, 24b each serving as an activation switch for a respective one of the driving support sub-modes; an OFF switch 24c serving as a stop switch; a cancel switch 24d; two vehicle speed setting switches 24e, 24f; and a resume switch 24g.

The preceding vehicle following sub-mode can be activated by manipulating (pushing down) the ON switch 24a. Further, the vehicle speed limiting sub-mode can be activated by manipulating the ON switch 24b. The activated state of each of the driving support sub-modes includes an active state and a standby state. In the active state, control (vehicle speed control) of changing a vehicle behavior through the engine control system 40 and/or the brake control system 42 is executed. The standby state is a state in which the vehicle behavior changing control is temporarily disabled.

By manipulating the OFF switch 24c, a currently-activated one of the driving support sub-modes can be deactivated, irrespective of whether it is in the active state or in the standby state. While the setup vehicle speed stored in the memory 11 of the ECU 10 is used during the activated state of the selected driving support sub-mode, the setup vehicle speed stored in the memory 11 is cleared (erased) by manipulating the OFF switch 24c.

By manipulating the cancel switch 24d, the currently-activated driving support sub-mode is switched from the active state to the standby state.

The setup vehicle speed can be increased from a current value thereof by manipulating the vehicle speed setting switches 24e. Further, the setup vehicle speed can be decreased from a current value thereof by manipulating the vehicle speed setting switches 24f. Upon input of the setup vehicle speed by a driver, the input setup vehicle speed is stored in the memory 11 of the ECU 10. For example, a driver can press one of the ON switches 24a, 24b, and then press one of the vehicle speed setting switches 24e, 24f to thereby input a current value of the vehicle speed of the vehicle 1 as the setup vehicle speed. Further, after storing the setup vehicle speed in the memory 11 in the above manner, the driver can manipulate one of the vehicle speed setting switches 24e, 24f so as to increase or decrease the setup vehicle speed.

As a basic manipulation function, the resume switch 24g is used such that it is manipulated to restart or resume the driving support sub-mode (to the active state), using the setup vehicle speed stored in the memory 11 of the ECU 10 when the currently-activated driving support sub-mode is in the standby state.

The navigation device 26 is operable to acquire a current position of the vehicle 1 by using the GPS or the like, and specify the position of the vehicle 1 on a map, based on stored map information or map information from an external source. Further, the navigation device 26 is operable to acquire a speed limit (sign-designated speed) assigned to a traveling road along which the vehicle 1 is traveling based on the current position on the map. Therefore, the navigation device 26 may be used as the speed limit recognition part.

The display unit 28 is installed to an instrument panel or the like, and comprises an activation state display field 28a, a setup vehicle speed display field 28b, and a speed limit display field 28c (see FIG. 4A). Although only one activation state display field 28a is depicted in FIG. 4A for the sake of facilitating understanding, it is to be understood that a plurality of activation state display fields may be provided correspondingly to respective ones of a plurality of driving support modes.

The activation state display field 28a is a display field for displaying the activation state of a selected one of the driving support sub-modes. On the activation state display field 28a, the execution state of the selected driving support sub-mode is displayed in the form of one of “BLANK (OFF)”, “ACTIVE” and “STANDBY”.

The setup vehicle speed display field 28b is a display field for displaying the setup vehicle speed (e.g., “80”) stored in the memory 11 of the ECU 10. Here, when no setup vehicle speed is stored in the memory 11, “BLANK (---)” is displayed on the setup vehicle speed display field 28b.

The speed limit display field 28c is a display field for displaying the acquired speed limit (e.g., “50”). Here, when no speed limit is acquired, “BLANK” is displayed on the speed limit display field 28c.

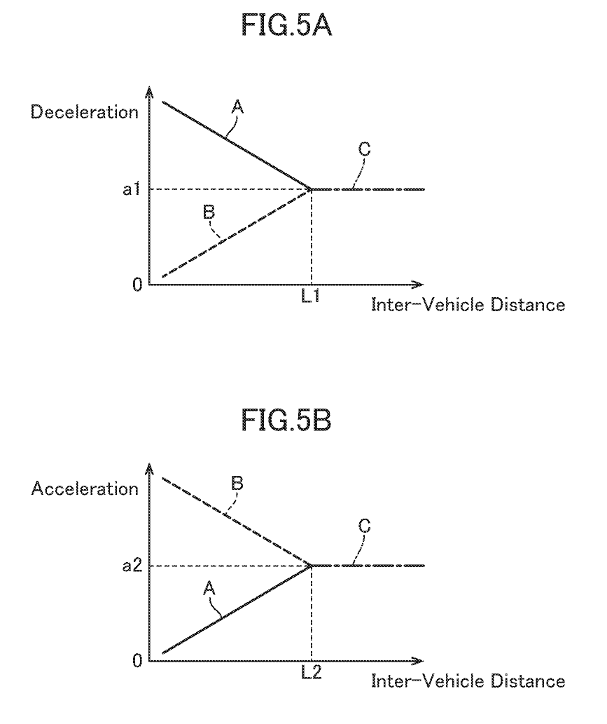

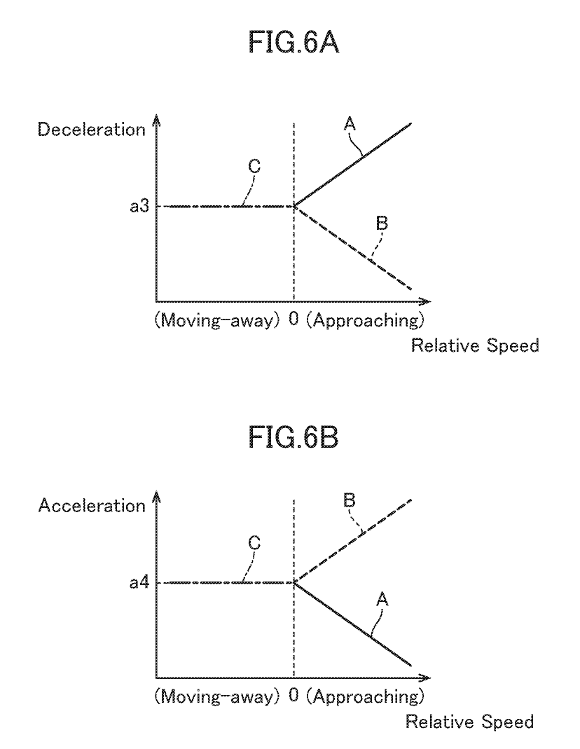

Next, with reference to FIGS. 3 to 6, the vehicle control in this embodiment will be described. FIG. 3 is an explanatory diagram of the vehicle control upon acquisition of a speed limit, and FIG. 4A and FIG. 4B are explanatory diagrams of the display unit. FIG. 5A and FIG. 5B are explanatory diagrams presenting the relationship between an inter-vehicle distance and an acceleration/deceleration, and FIG. 6A and FIG. 6B are explanatory diagrams presenting the relationship between a relative speed and an acceleration/deceleration.

In FIG. 3, the vehicle 1 is traveling along a traveling road 3 at 80 km/h (V=80) (position A). At the position A, the speed limit is 80 km/h. Further, a forward vehicle 2a is traveling forward of (ahead of) the vehicle 1, and a rearward vehicle 2b is traveling rearward of (behind) the vehicle 1.

At the position A, information is displayed on the display unit 28 of the vehicle 1, as depicted in FIG. 4A. In this case, the driving support mode is in the active state (“ACTIVE”), and the setup vehicle speed is 80 km/h (“80 km/h”) and the speed limit is also 80 km/h (“80”).

As the driving support mode, one of the preceding vehicle following sub-mode and the vehicle speed limiting sub-mode is selected. During the vehicle speed control in the preceding vehicle following sub-mode, an automatic increase and an automatic decrease in vehicle speed of the vehicle 1 are executed. On the other hand, during the vehicle speed control in the vehicle speed limiting sub-mode, only an automatic decrease in vehicle speed of the vehicle 1 is executed, wherein the vehicle speed of the vehicle 1 can be increased according to manipulation of the accelerator pedal by a driver.

At a position B before a speed sign 5, the vehicle 1 detects the speed sign 5 (speed limit “50 km/h”) provided beside the traveling road 3. Upon acquiring the speed limit from the detected speed sign 5, the ECU 10 operates to write (store) the acquired speed limit (50 km/h) in the memory 11 so as to update the current value (80 km/h) of the speed limit stored in the memory 11, and overwrite the setup vehicle speed (80 km/h) stored in the memory 11 with the speed limit (50 km/h). Thus, after the elapse of a given time period from the detection of the speed sign 5, information is displayed on the display unit 28, as depicted in FIG. 4B. That is, a new speed limit (“50”) is displayed on the speed limit display field 28c, and a new setup vehicle speed (“50 km/h”) is displayed on the setup vehicle speed display field 28b.

In this embodiment, in response to detection of a speed sign 5, the setup vehicle speed is automatically rewritten with the limit speed designated by the speed sign. Alternatively, the rewriting may be executed in response to manipulation by a driver. For example, when a driver manipulates (presses) the resume switch 24g at the position B, the speed limit is stored as the setup speed in the memory 11 in response to the manipulation of the resume switch 24g, and thus a new setup vehicle speed is displayed on the setup vehicle speed display field 28b.

When the setup vehicle speed is changed from 80 km/h to 50 km/h, the vehicle control device 10 executes the vehicle speed control through the engine control system 40 and the brake control system 42, using the new setup vehicle speed as a target vehicle speed. In this case, the vehicle speed of the vehicle 1 is decreased from 80 km/h to 50 km/h.

In this embodiment, when the vehicle speed of the vehicle 1 is increased or decreased to the new setup vehicle speed (=the speed limit) by the vehicle speed control associated with change in the setup speed, an acceleration/deceleration is set depending on the presence or absence of the second vehicle (the forward vehicle or the rearward vehicle). Specifically, the acceleration/deceleration is set depending on an inter-vehicle distance and/or a relative speed between the second vehicle and the vehicle 1. When the new setup vehicle speed is greater than a current value of the vehicle speed of the vehicle 1, the vehicle speed of the vehicle 1 is increased (only in the preceding vehicle following mode). On the other hand, when the new setup vehicle speed is less than a current value of the vehicle speed of the vehicle 1, the vehicle speed of the vehicle 1 is decreased (in the preceding vehicle following mode and the vehicle speed limiting sub-mode).

FIG. 5A and FIG. 5B present the relationship between the inter-vehicle distance and the acceleration/deceleration, wherein FIG. 5A presents a deceleration in the case where the vehicle speed of the vehicle 1 is decreased, and FIG. 5B presents an acceleration in the case where the vehicle speed of the vehicle 1 is increased. The ECU 10 stores in the memory 11, data indicative of the relationship in FIG. 5A and FIG. 5B. In FIG. 5A and FIG. 5B, the vehicle speed of the vehicle 1 is not taken into consideration. However, it is to be understood that a plurality of pieces of data may be prepared with respect to a plurality of different vehicle speeds of the vehicle 1.

As presented in FIG. 5A, the deceleration is set to a larger value relative to a given reference value a1 (see the solid line A) as the inter-vehicle distance with respect to the forward vehicle is smaller, and the deceleration is set to a smaller value relative to the reference value a1 (see the broken line B) as the inter-vehicle distance with respect to the rearward vehicle is smaller. Further, when the inter-vehicle distance with respect to the forward vehicle or the inter-vehicle distance with respect to the rearward vehicle is greater than a given inter-vehicle distance L1 (including a situation where no second vehicle exists within a given setup distance), the deceleration is set to the reference value a1. As above, in this embodiment, when the forward vehicle or the rearward vehicle is located close to the vehicle 1, the deceleration is set to allow the vehicle 1 to quickly move away from the forward vehicle or to make the vehicle 1 less likely to approach the rearward vehicle.

On the other hand, as presented in FIG. 5B, the acceleration is set to a smaller value relative to a given reference value a2 (see the solid line A) as the inter-vehicle distance with respect to the forward vehicle is smaller, and the acceleration is set to a larger value relative to the reference value a2 (see the broken line B) as the inter-vehicle distance with respect to the rearward vehicle is smaller. Further, when the inter-vehicle distance with respect to the forward vehicle or the inter-vehicle distance with respect to the rearward vehicle is greater than a given inter-vehicle distance L2 (including a situation where no second vehicle exists within a given setup distance), the acceleration is set to the reference value a2. As above, in this embodiment, when the forward vehicle or the rearward vehicle is located close to the vehicle 1, the acceleration is set to make the vehicle 1 less likely to approach the forward vehicle or to allow the vehicle 1 to quickly move away from the rear ward vehicle.

FIG. 6A and FIG. 6B present the relationship between the relative speed and the acceleration/deceleration, wherein FIG. 6A presents a deceleration in the case where the vehicle speed of the vehicle 1 is decreased, and FIG. 6B presents an acceleration in the case where the vehicle speed of the vehicle 1 is increased. In FIG. 6A and FIG. 6B, the vehicle speed of the vehicle 1 is not taken into consideration. However, it is to be understood that a plurality of pieces of data may be prepared with respect to a plurality of different vehicle speeds of the vehicle 1. Regarding the relative speed, a direction along which the vehicle 1 approaches each of the second vehicles 1 is defined as a positive (plus) relative speed.

As presented in FIG. 6A, the deceleration is set to a larger value relative to a given reference value a3 (see the solid line A) as the relative speed with respect to the forward vehicle is larger, and the deceleration is set to a smaller value relative to the reference value a3 (see the broken line B) as the relative speed with respect to the rearward vehicle is larger. Further, when the second vehicle is moving away from the vehicle 1 (relative speed<0), or when no second vehicle exists within a given setup distance, the deceleration is set to the reference value a3. As above, in this embodiment, when the forward vehicle or the rearward vehicle is approaching the vehicle 1 at a large relative speed, the deceleration is set to make the vehicle 1 less likely to approach the forward vehicle or the rearward vehicle.

On the other hand, as presented in FIG. 6B, the acceleration is set to a smaller value relative to a given reference value a4 (see the solid line A) as the relative speed with respect to the forward vehicle is larger, and the acceleration is set to a larger value relative to the reference value a4 (see the broken line B) as the relative speed with respect to the rearward vehicle is larger. Further, when the second vehicle is moving away from the vehicle 1 (relative speed<0), or when no second vehicle exists within a given setup distance, the acceleration is set to the reference value a4. As above, in this embodiment, when the forward vehicle or the rearward vehicle is approaching the vehicle 1 at a large relative speed, the acceleration is set to make the vehicle 1 less likely to approach the forward vehicle or the rearward vehicle.

In FIGS. 5 and 6, the acceleration/deceleration is set depending on one of the inter-vehicle distance and the relative speed. Alternatively, the acceleration/deceleration may be set while taking into account both of the inter-vehicle distance and the relative speed. For example, in a situation where there is the forward vehicle or the rearward vehicle, and the vehicle speed of the vehicle 1 is decreased or increased, a larger one (in terms of an absolute value) of the acceleration/deceleration set based on the inter-vehicle distance and the acceleration/deceleration set based on the relative speed may be selected. Specifically, in a situation where the vehicle speed of the vehicle 1 is decreased when the forward vehicle is traveling, a larger one of the deceleration set based on the inter-vehicle distance and the deceleration set based on the relative speed may be selected. Alternatively, the acceleration/deceleration set based on the inter-vehicle distance and the acceleration/deceleration set based on the relative speed may be multiplied, respectively, by each given coefficient (each set to e.g., 0.5), and the resulting values may be added.

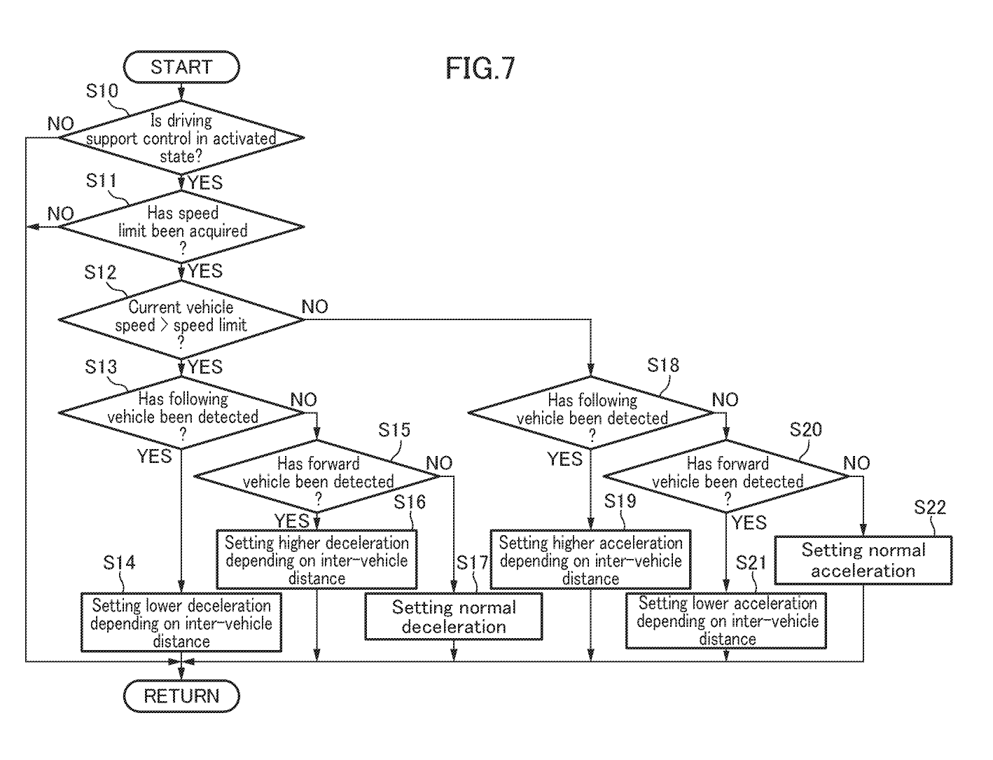

Next, with reference to FIG. 7, a process flow of vehicle control processing in this embodiment will be described.

The ECU 10 (control part 10a) repeatedly executes the process flow in FIG. 7 at given time intervals. The ECU 10 (control part 10a) serving as a traveling vehicle detection part operates to constantly calculate the presence or absence of the second vehicle (preceding vehicle or following vehicle), the inter-vehicle distance, and the relative speed from measurement data of the radar 22, and store the calculated data in the memory 11 only for a given time period. Further, the ECU 10 (speed limit recognition part 10b) operates to execute the speed limit recognition processing by a different processing routine, and store the recognized speed limit in the memory 11.

Upon start of the vehicle control processing, the ECU 10 operates to determine whether or not the driving support mode is in the activated state (including the standby state) (S10). If the driving support mode is not in the activated state (S10; NO), the ECU 10 operates to terminate the processing. On the other hand, if the driving support mode is in the activated state (S10; YES), the ECU 10 operates to determine whether or not a speed limit (sign-designated speed) has been acquired (S11).

If no speed limit has been acquired (S11; NO), the ECU 10 terminates the processing. On the other hand, if a speed limit has been acquired (S11; YES), the ECU 10 operates to rewrite the setup speed stored in the memory 11 with the acquired speed limit. Thus, the same speed (speed limit) as that in the speed limit display field 28c is displayed on the setup vehicle speed display field 28b of the display unit 28 (see FIG. 4B).

Subsequently, the ECU 10 operates to determine whether or not a current value of the vehicle speed is greater than the setup speed (=the acquired speed limit) (S12). If the current vehicle speed is greater than the setup speed (S12; YES), the ECU 10 operates to set a deceleration in the following steps S14 to S17, so as to execute vehicle speed decreasing processing for decreasing the vehicle speed of the vehicle 1 in vehicle speed control processing.

In setting the deceleration, the ECU 10 operates to determine whether or not a rearward vehicle exists within a given setup distance (S13). If a rearward vehicle exists (S13; YES), the ECU 10 operates to set the deceleration based on an inter-vehicle distance between the vehicle 1 and the rearward vehicle (see the vehicle 2b in FIG. 3) (S14), and terminates the processing. For example, from the relationship between the inter-vehicle distance and the deceleration (see the broken line B in FIG. 5A), the ECU 10 can acquire a value of the deceleration corresponding to the above inter-vehicle distance.

On the other hand, if no rearward vehicle exists (S13; NO), the ECU 10 operates to determine whether or not a forward vehicle exists within a given setup distance (S15). If no rearward vehicle exists and a forward vehicle exists (S15; YES), the ECU 10 operates to set the deceleration based on an inter-vehicle distance between the vehicle 1 and the forward vehicle (see the vehicle 2a in FIG. 3) (S16), and terminates the processing. For example, from the relationship between the inter-vehicle distance and the deceleration (see the solid line A in FIG. 5A), the ECU 10 can acquire a value of the deceleration corresponding to the above inter-vehicle distance.

Further, if neither a rearward vehicle nor a forward vehicle exists (S15; NO), the ECU 10 operates to select a given deceleration (see the reference value a1 in FIG. 5A) (S17), and terminates the processing.

In the steps S13 to S17, the vehicle speed of the vehicle 1 is decreased. Thus, in order to prevent the vehicle 1 from coming into collision with the rearward vehicle due to reduction in vehicle speed, the rearward vehicle is detected prior to detection of the forward vehicle.

On the other hand, if the current vehicle speed is equal to or less than the setup speed (=the speed limit) (S12; NO), the ECU 10 operates to set an acceleration in the following steps S18 to S22, so as to execute vehicle speed increasing processing for increasing the vehicle speed of the vehicle 1 in vehicle speed control processing.

In setting the acceleration, the ECU 10 operates to determine whether or not a rearward vehicle exists within a given setup distance (S18). If a rearward vehicle exists (S18; YES), the ECU 10 operates to set the acceleration based on an inter-vehicle distance between the vehicle 1 and the rearward vehicle (S19), and terminates the processing. For example, from the relationship between the inter-vehicle distance and the acceleration (see the broken line B in FIG. 5B), the ECU 10 can acquire a value of the acceleration corresponding to the above inter-vehicle distance.

On the other hand, if no rearward vehicle exists (S18; NO), the ECU 10 operates to determine whether or not a forward vehicle exists within a given setup distance (S20). If no rearward vehicle exists and a forward vehicle exists (S20; YES), the ECU 10 operates to set the acceleration based on an inter-vehicle distance between the vehicle 1 and the forward vehicle (S21), and terminates the processing. For example, from the relationship between the inter-vehicle distance and the acceleration (see the solid line A in FIG. 5B), the ECU 10 can acquire a value of the acceleration corresponding to the above inter-vehicle distance.

Further, if neither a rearward vehicle nor a forward vehicle exists (S20; NO), the ECU 10 operates to select a given acceleration (see the reference value a2 in FIG. 5B) (S22), and terminates the processing.

In the steps S18 to S22, the vehicle speed of the vehicle 1 is increased. Thus, in order to prevent the vehicle 1 from coming into collision with the forward vehicle due to increase in vehicle speed, the forward vehicle is detected prior to detection of the rearward vehicle.

After setting the deceleration or acceleration in the above manner, the ECU 10 operates to output request signals, respectively, to the engine control system 40 and the brake control system 42, so as to change the vehicle speed to the setup vehicle speed at the set acceleration/deceleration. The processing for increasing the vehicle speed is executed only in the preceding vehicle following sub-mode. In the vehicle speed limiting sub-mode, the vehicle speed increasing processing (S18 to S22) is not executed.

In the process flow in FIG. 7, the inter-vehicle distance is used when setting the acceleration/deceleration. Alternatively, the relative speed (see FIG. 6A and FIG. 6B) may be used in place of the inter-vehicle distance, or both of the inter-vehicle distance and the relative speed may be used.

Next, operations of the vehicle control device according to this embodiment will be described.

The vehicle control device 100 according to this embodiment comprises: the control part (ECU 10) operable to execute vehicle speed control for the vehicle 1 during execution of the driving support mode; the speed limit recognition part (ECU 10, navigation device 26) operable to acquire the speed limit assigned to the traveling road 3; and the traveling vehicle detection part (ECU 10) operable to acquire the inter-vehicle distance and/or the relative speed with respect to the second vehicles 2a, 2b being traveling forward or rearward of the vehicle 1, wherein the control part (ECU 10) is configured to increase or decrease the vehicle speed of the vehicle 1 to the speed limit during the vehicle speed control, and wherein the control part (ECU 10) is operable to set the acceleration or the deceleration of the vehicle 1 during the vehicle speed control according to the inter-vehicle distance and/or the relative speed with respect to the second vehicles 2a, 2b (S13 to S22).

In the vehicle control device according to this embodiment, the speed limit assigned to the traveling road 3 is acquired, and the vehicle speed is controlled such that it is changed toward the speed limit. Here, if there is a second vehicle (a forward vehicle or a rearward vehicle) in the vicinity of the vehicle 1, the vehicle 1 is likely to further approach the second vehicle when the vehicle speed is increased or decreased. Therefore, in this embodiment, the acceleration or the deceleration of the vehicle 1 is set according to the inter-vehicle distance and/or the relative speed between the vehicle 1 and the second vehicle. This makes it possible to prevent approaching of the vehicle 1 to the second vehicle when there is a change in vehicle speed during the vehicle speed control, and to thereby improve safety.

Specifically, in the vehicle control device according to this embodiment, when reducing the vehicle speed of the vehicle 1 to the speed limit during the vehicle speed control (S15; YES), the control part (ECU 10) is operable to set the deceleration to a larger value as the inter-vehicle distance with respect to the forward vehicle is smaller (the solid line A in FIG. 5A) and/or as the relative speed at which the forward vehicle approaches the vehicle 1 is larger (the solid line A in FIG. 6A). According to this feature, when the forward vehicle is located closer to the vehicle 1 and/or when the forward vehicle approaches the vehicle 1 at a higher relative speed, it is possible to reduce the vehicle speed of the vehicle 1 at a larger deceleration to thereby enable the vehicle 1 to be promptly distanced from the forward vehicle.

Specifically, in the vehicle control device according to this embodiment, when reducing the vehicle speed of the vehicle 1 to the speed limit during the vehicle speed control (S13; YES), the control part (ECU 10) is operable to set the deceleration to a smaller value as the inter-vehicle distance with respect to the rearward vehicle is smaller (the broken line B in FIG. 5A) and/or as the relative speed at which the rearward vehicle approaches the vehicle 1 is larger (the broken line B in FIG. 6A). According to this feature, when the rearward vehicle is located closer to the vehicle 1 and/or when the rearward vehicle approaches the vehicle 1 at a higher relative speed, it is possible to reduce the vehicle speed of the vehicle 1 at a smaller deceleration to thereby reduce the relative speed at which the rearward vehicle approaches the vehicle 1.

Specifically, in the vehicle control device according to this embodiment, when increasing the vehicle speed of the vehicle 1 to the speed limit during the vehicle speed control (S20; YES), the control part (ECU 10) is operable to set the acceleration to a smaller value as the inter-vehicle distance with respect to the forward vehicle is smaller (the solid line A in FIG. 5B) and/or as the relative speed at which the forward vehicle approaches the vehicle 1 is larger (the solid line A in FIG. 6B). According to this feature, when the forward vehicle is located closer to the vehicle 1 and/or when the forward vehicle approaches the vehicle 1 at a higher relative speed, it is possible to increase the vehicle speed of the vehicle 1 at a smaller acceleration to thereby reduce the relative speed at which the forward vehicle approaches the vehicle 1.

Specifically, in the vehicle control device according to this embodiment, when increasing the vehicle speed of the vehicle 1 to the speed limit during the vehicle speed control (S18; YES), the control part (ECU 10) is operable to set the acceleration to a larger value as the inter-vehicle distance with respect to the rearward vehicle is smaller (the broken line B in FIG. 5B) and/or as the relative speed at which the rearward vehicle approaches the vehicle 1 is larger (the broken line B in FIG. 6B). According to this feature, when the rearward vehicle is located closer to the vehicle 1 and/or when the rearward vehicle approaches the vehicle 1 at a higher relative speed, it is possible to increase the vehicle speed of the vehicle 1 at a larger acceleration to thereby enable the vehicle 1 to be promptly distanced from the rearward vehicle.

### LIST OF REFERENCE SIGNS

1: vehicle
10: control unit
100: vehicle control device

1. A vehicle control device comprising:
a control part operable to execute vehicle speed control for a vehicle during execution of a driving support mode;
a speed limit recognition part operable to acquire a speed limit assigned to a traveling road; and
a traveling vehicle detection part operable to acquire an inter-vehicle distance and/or a relative speed with respect to a second vehicle being traveling forward or rearward of the vehicle,
wherein the control part is configured to increase or decrease the vehicle speed of the vehicle to the speed limit during the vehicle speed control, and the control part is operable to set an acceleration or a deceleration of the vehicle during the vehicle speed control according to the inter-vehicle distance and/or the relative speed with respect to the second vehicle.

2. The vehicle control device as recited in claim 1, wherein, when decreasing the vehicle speed of the vehicle to the speed limit during the vehicle speed control, the control part is operable to set the deceleration to a larger value, as the inter-vehicle distance with respect to the forward vehicle is smaller and/or as the relative speed at which the forward vehicle approaches the vehicle is larger.

3. The vehicle control device as recited in claim 1, wherein, when decreasing the vehicle speed of the vehicle to the speed limit during the vehicle speed control, the control part is operable to set the deceleration to a smaller value, as the inter-vehicle distance with respect to the rearward vehicle is smaller and/or as the relative speed at which the rearward vehicle approaches the vehicle is larger.

4. The vehicle control device as recited in claim 1, wherein, when increasing the vehicle speed of the vehicle to the speed limit during the vehicle speed control, the control part is operable to set the acceleration to a smaller value, as the inter-vehicle distance with respect to the forward vehicle is smaller and/or as the relative speed at which the forward vehicle approaches the vehicle is larger.

5. The vehicle control device as recited in claim 1, wherein, when increasing the vehicle speed of the vehicle to the speed limit during the vehicle speed control, the control part is operable to set the acceleration to a larger value, as the inter-vehicle distance with respect to the rearward vehicle is smaller and/or as the relative speed at which the rearward vehicle approaches the vehicle is larger.

6. A vehicle control device comprising:
a control unit configured to execute vehicle speed control for a vehicle during execution of a driving support mode; to acquire a speed limit assigned to a traveling road; and to acquire an inter-vehicle distance and/or a relative speed with respect to a second vehicle being traveling forward or rearward of the vehicle,
wherein the control unit is further configured to increase or decrease the vehicle speed of the vehicle to the speed limit during the vehicle speed control, and to set an acceleration or a deceleration of the vehicle during the vehicle speed control according to the inter-vehicle distance and/or the relative speed with respect to the second vehicle.
